(19) United States
(12) Patent Application Publication
(10) Pub. No.: US 2019/0307058 A1
(43) Pub. Date: Oct. 10, 2019

(54) SEEDING DEVICE

(71) Applicant: Norman Robbins, Woodburn, IA (US)

(72) Inventor: Norman Robbins, Woodburn, IA (US)

(21) Appl. No.: 16/340,190

(22) PCT Filed: Oct. 17, 2017
(86) PCT No.: PCT/US17/56955

§ 371 Date: Apr. 8, 2019

Related U.S. Application Data
(60) Provisional application No. 62/409,181, filed on Oct. 17, 2016.

(51) Int. Cl. A01C 7/08; B64D 1/16; A01C 14/00

(52) U.S. Cl. CPC A01C 7/081; A01C 14/00; B64D 1/16

(57) ABSTRACT

A seeding device system is presented for use with helicopters and other vehicles. The system includes a bulk seed container, a feed tube that connects the seed container to a metering device that precisely meters out seed, a flow control system that controls operation of the metering device, and a blower connected to a venturi that blows the seed outward from the helicopter. When seed is metered out of the metering device, the seed is sucked into the venturi and blown outward. The seed container is held in the back seat or cargo area of the helicopter and the blower, venturi and metering device are positioned exterior to the helicopter. This arrangement does not adversely affect the operational characteristics or aerodynamic properties of the helicopter. In addition, all components of the system are rigidly connected to the helicopter thereby increasing safety and control of the helicopter.

### CROSS REFERENCE TO RELATED PATENT APPLICATIONS

This application is a 371 of international PCT/US17/56955 which was filed on Oct. 17, 2017, which also claims priority to U.S. Provisional Patent Application 62/409,181 filed on Oct. 17, 2016 which is fully incorporated by reference herein.

### FIELD OF THE INVENTION

This invention relates to a material handling device. More specifically and without limitation, this invention relates to a material handling device that can be used to broadly disperse fine particulate matter and therefore is useful in spreading cover crop seeds.

### BACKGROUND OF THE INVENTION

Erosion, pollution, soil health and maximum productivity are major concerns and important considerations for modern farming operations. To help alleviate erosion and pollution as well as improve soil health and productivity, there has been increased interest in the use of cover crops by many farmers.

The term cover crop applies to the practice of spreading a secondary crop to a field at or around the time that the primary crop (such as corn, soybeans or the like) reaches its maturity. The purpose of the cover crop is not to be harvested. Instead, the purpose of a cover crop is to grow after the primary crop has been harvested, sometimes even through the winter. In doing so, the cover crop adds biomass and plant matter to the field, helps prevent erosion, increases biodiversity in the field, improves soil structure, helps to retain water, adds porosity to the soil, helps prevent or reduce pests, and adds nutrients to the soil, among countless other benefits. In Iowa, where primary crops consist largely of corn and soybeans, common cover crops include oats, rye, wheat, radishes, barley, various grasses, mustard, carrots, alfalfa, and clover, among countless others.

One substantial challenge in the use of cover crops is how to spread the cover crop seeds. This is because the cover crop seeds need to be spread towards the end of the growing season of the primary crop. At this time the primary crop is generally at its full maturity and has filled in the rows thereby making the fields essentially inaccessible from the ground without driving over and substantially damaging the valuable primary crop. While attempts have been made to add cover crops via the ground, the damage incurred to the primary crop makes seeding from the ground highly undesirable.

Various attempts have been made to utilize aircraft to add cover crop seeds to fields. However, all of these attempts have substantial disadvantages.

Various attempts have been made to use fixed wing aircraft to apply cover crop seeds to fields. However, the use of fixed wing aircraft to spread cover crop seeds has substantial disadvantages. Namely, due to the fact that fixed wing aircraft must move forward at a rapid pace to remain in the air, it is difficult if not impossible to add cover crop seed with any level of precision due to the speeds involved. In addition, due to the aerodynamic properties of fixed wing aircraft, the dynamics of the airflow behind the aircraft substantially effect the dispersion of cover crop seed after it is released, making the distribution of the cover crop when it hits the ground substantially uneven.

In addition, as a practical matter, adding cover crop seed to a field requires frequent refills due to the weight and bulk of the cover crop seed. When using a fixed wing aircraft, the aircraft must return to the airport each time a refill is required. Depending on the location of the airport and the field, this can be inconvenient and will likely add a substantial amount of flying time and cost to the application process.

Various attempts have been made to use helicopters to apply cover crop seeds to fields. One such attempt is known as the Isolair “Dryslinger” manufactured by Isolair Helicopter Systems, 27600 SE HWY 212, Boring, Oreg. 97009. The Dryslinger system includes a bucket connected to the helicopter by a tether. The bucket holds a bulk amount of seed and hangs down below the helicopter during flight. The bucket includes a spinning device that broadcasts the seed as the helicopter travels across the field.

While effective in some ways, the Dryslinger system suffers from many substantial disadvantages. Namely, with the heavy bucket hanging below the helicopter this creates a pendulum effect and makes the helicopter very challenging to control as well as the bucket. In addition, because this external bucket affects the flying properties of the helicopter, additional certifications and training are required to operate this system.

Furthermore, with the bucket hanging below the helicopter it is difficult or impossible for the pilot to know where the bucket is at all times. This causes substantial safety concerns, especially when flying near power lines, trees, buildings, and other obstructions. To compensate for the pilots inability to predict the position of the bucket, from a practical standpoint the pilot will err on the side of caution and either fly higher than is optimal or remain farther away from the obstructions than is optimal.

In addition to these disadvantages, the Dryslinger system does not provide an accurate and consistent dispersal of seeds. This is because it is impossible to fully control the position of the bucket below the helicopter as it swings on the end of the tether. As such, while the pilot may put the aircraft in the optimal position, the bucket, and therefore the seed, may be substantially off target.

Another substantial disadvantage to the Dryslinger system its utilization of a spinning impeller system to spread the seeds. This spinning impeller system has a tendency to throw heavier seeds farther than lighter seeds, which can cause an uneven distribution when spreading a mixture of various seeds. In addition, because the impeller tosses seeds in a circular pattern (which includes in front of the helicopter as well as behind the helicopter) while the helicopter travels forward, due to these combined effects this causes an increased density of seeds directly underneath the path of travel of the bucket, and less seeds the farther away from the helicopter. In addition, because the spinning impeller requires physical contact to sling the seed outward, the contact between the impeller and the seed has a tendency to damage a high percentage of seed thereby substantially reducing the germination rate of the seeds.

Further complexities occur when operating the Dryslinger system due to helicopter ground effect. Ground effect is a condition of improved performance encountered when operating near the ground. It is due to the interference of the surface with the airflow pattern of the rotor system, and it is more pronounced the nearer the ground is approached. Increased blade efficiency while operating in ground effect is due to two separate and distinct phenomena.

First and most important is the reduction of the velocity of the induced airflow. Since the ground interrupts the airflow under the helicopter, the entire flow is altered. This reduces downward velocity of the induced flow. The result is less induced drag and a more vertical lift vector. The lift needed to sustain a hover can be produced with a reduced angle of attack and less power because of the more vertical lift vector:

The second phenomenon is a reduction of the rotor tip vortex. When operating in ground effect, the downward and outward airflow pattern tends to restrict vortex generation. This makes the outboard portion of the rotor blade more efficient and reduces overall system turbulence caused by ingestion and recirculation of the vortex swirls.

If a helicopter hovering out-of-ground-effect descends into a ground-effect hover, blade efficiency increases because of the more favorable induced flow. As efficiency of the rotor system increases, the pilot reduces blade pitch angle to remain in the ground-effect hover. Less power is required to maintain however in-ground-effect than for the out-of-ground-effect hover.

Due to the Dryslinger hanging below the helicopter, helicopter ground effect complicates use of the Dryslinger. That is, upon liftoff, of the helicopter, when the helicopter is in ground effect and at its highest level of efficiency, the heavy Dryslinger remains on the ground. It is only when the helicopter elevates that it begins to pick up the weight of the Dryslinger, which is at or around the time the helicopter comes out of ground effect. It is at this point that the pilot must simultaneously deal with the changing performance characteristics of the helicopter while picking up the weight of the Dryslinger. This is a complex task that requires a high level of concentration and skill with catastrophic consequences if performed improperly. It is for these reasons that additional qualifications and training is required to use the Dryslinger or similar devices.

As such, the Dryslinger device suffers from many substantial disadvantages including: being hard to control, having safety concerns, requires additional training, poor operational performance, requires special attention and care, and disperses seeds in a substantially uneven manner.

Therefore, for all the reasons stated above, and the reasons stated below, there is a need in the art for an improved seeding device and method of use.

Thus, it is a primary object of the invention to provide a seeding device and method of use that improves upon the state of the art.

Another object of the invention is to provide a seeding device and method of use that is safe to use.

Yet another object of the invention is to provide a seeding device and method of use that is efficient to use.

Another object of the invention is to provide a seeding device and method of use that is simpler to use than prior art methods.

Yet another object of the invention is to provide a seeding device and method of use that additionally allows a training pilot to gain flying hours.

Another object of the invention is to provide a seeding device and method of use that does not require additional pilot certifications.

Yet another object of the invention is to provide a seeding device and method of use that does not place additional limitations on the operation of the aircraft.

Another object of the invention is to provide a seeding device and method of use that is accurate.

Yet another object of the invention is to provide a seeding device and method of use that provides an even dispersion of seeds.

Another object of the invention is to provide a seeding device and method of use that does not hang down from the helicopter.

Yet another object of the invention is to provide a seeding device and method of use that does not damage seeds.

Another object of the invention is to provide a seeding device and method of use that is less expensive to use than prior art systems.

Yet another object of the invention is to provide a seeding device and method of use that is easier to use than prior art systems.

Another object of the invention is to provide a seeding device and method of use that is relatively inexpensive.

Yet another object of the invention is to provide a seeding device and method of use that provides helicopter owners another avenue of use and revenue.

Another object of the invention is to provide a seeding device and method of use that has an intuitive design.

Yet another object of the invention is to provide a seeding device and method of use that is rigidly affixed to the helicopter.

Another object of the invention is to provide a seeding device and method of use that is formed of a minimum number of parts.

Yet another object of the invention is to provide a seeding device and method of use that does not require substantial electrical draw from the helicopter.

Another object of the invention is to provide a seeding device and method of use that has a long useful life.

Yet another object of the invention is to provide a seeding device and method of use that is durable.

Another object of the invention is to provide a seeding device and method of use that does not require flying the helicopter in a special manner or with special precautions.

Yet another object of the invention is to provide a seeding device and method of use that does not affect the execution of established emergency procedures.

Another object of the invention is to provide a seeding device and method of use that is easy to manufacture.

Yet another object of the invention is to provide a seeding device and method of use that has a robust design.

Another object of the invention is to provide a seeding device and method of use that is high quality.

Another object of the invention is to provide a seeding device and method of use that can be reconfigured to suit the unique characteristics of other aircraft or other vehicles.

Yet another object of the invention is to provide a seeding device and method of use that can be used with ground vehicles.

Another object of the invention is to provide a seeding device and method of use that can be used with practically any helicopter.

Yet another object of the invention is to provide a seeding device and method of use that improves efficiencies.

Another object of the invention is to provide a seeding device and method of use that can be used with a helicopter while meeting FAA Part 91 regulations (14 C.F.R. 91) General Operating and Flight Rules.

Yet another object of the invention is to provide a seeding device and method of use that places the primary weight of the system in approximately the areas designed to hold the weight of passengers and/or cargo.

These and other objects, features, or advantages of the invention will become apparent from the specification, figures and claims.

### SUMMARY OF THE INVENTION

A seeding device system is presented for use with helicopters and other vehicles. The system includes a bulk seed container, a feed tube that connects the seed container to a metering device that precisely meters out seed, a flow control system that controls operation of the metering device, and a blower connected to a venturi that blows the seed outward from the helicopter. When seed is metered out of the metering device, the seed is sucked into the venturi and blown outward. The seed container is held in the back seat or cargo area of the helicopter and the blower, venturi and metering device are positioned exterior to the helicopter. This arrangement does not adversely affect the operational characteristics or aerodynamic properties of the helicopter. In addition, all components of the system are rigidly connected to the helicopter thereby increasing safety and control of the helicopter.

### BRIEF DESCRIPTION OF THE DRAWINGS

FIG. 1 is an elevation view of a helicopter, the view showing a side of the helicopter; the view showing a seeding device connected to the helicopter; the view showing the seeding device having a bottom plate that is connected to the fuselage of the helicopter using a plurality of braces; the view showing a bin positioned in the back seat or cargo area of the helicopter; the view showing the bin connected to a metering device that meters seed out of the bin, the bin and metering device connected by a feed tube that carries seed from the bin to the metering device; the view showing the metering device connected to a venturi by an inlet tube, the inlet tube configured to carry seed from the metering device to the venturi; the view showing the venturi connected to a blower by an air tube, the air tube configured to carry pressurized air to the venturi;

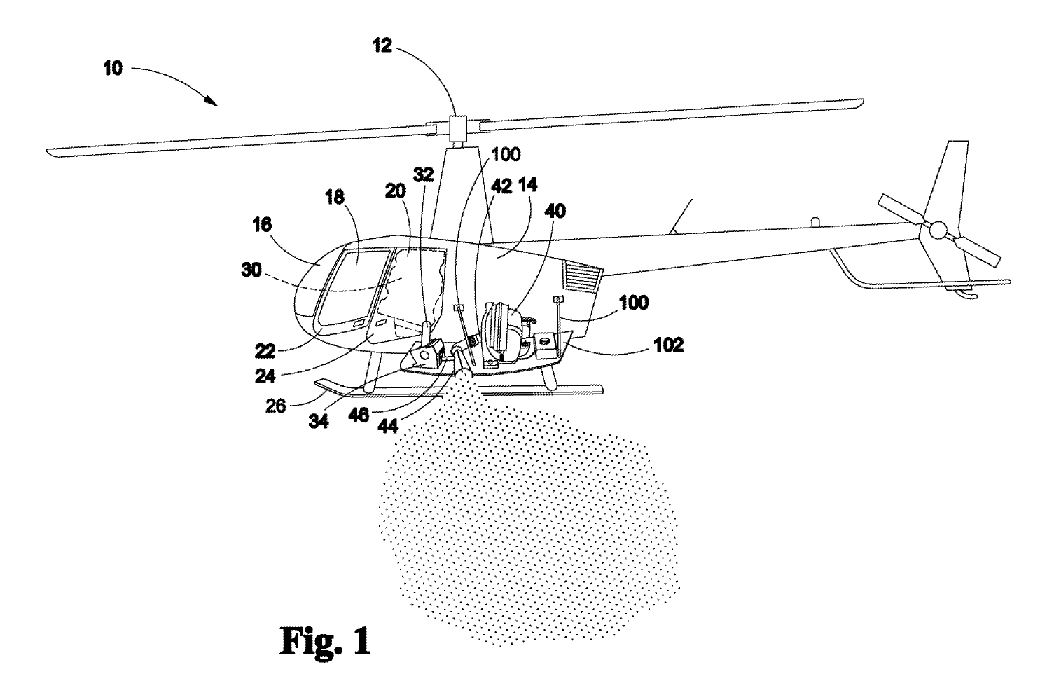

FIG. 2 is an elevation view of the helicopter of FIG. 1, the view showing a top side of the helicopter; the view showing a seeding device connected to opposing sides of the helicopter; the view showing the seeding device having a bottom plate that is connected to the fuselage of the helicopter using a plurality of braces; the view showing a bin positioned in the back seat or cargo area of the helicopter; the view showing the bin connected to a metering device that meters seed out of the bin, the bin and metering device connected by a feed tube that carries seed from the bin to the metering device; the view showing the metering device connected to a venturi by an inlet tube, the inlet tube configured to carry seed from the metering device to the venturi; the view showing the venturi connected to a blower by an air tube, the air tube configured to carry pressurized air to the venturi;

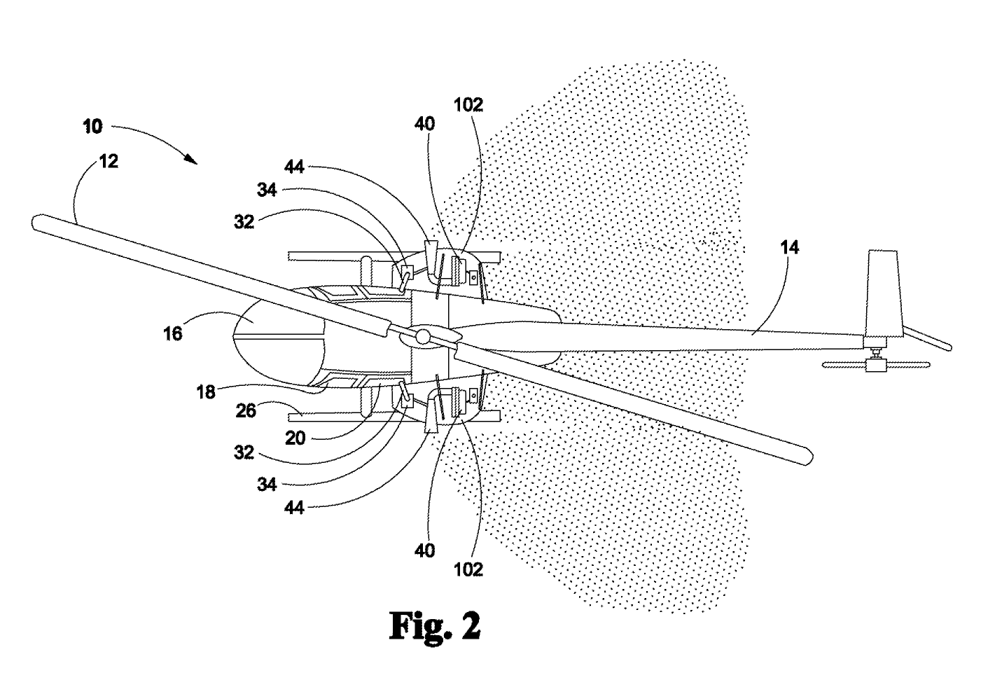

FIG. 3 is an elevation view of the helicopter of FIGS. 1 and 2, the view showing a front side of the helicopter; the view showing a seeding device connected to opposing sides of the helicopter; the view showing the seeding device having a bottom plate that is connected to the fuselage of the helicopter using a plurality of braces; the view showing a bin positioned in the back seat or cargo area of the helicopter; the view showing the bin connected to a metering device that meters seed out of the bin, the bin and metering device connected by a feed tube that carries seed from the bin to the metering device; the view showing the metering device connected to a venturi by an inlet tube, the inlet tube configured to carry seed from the metering device to the venturi; the view showing the venturi connected to a blower by an air tube, the air tube configured to carry pressurized air to the venturi;

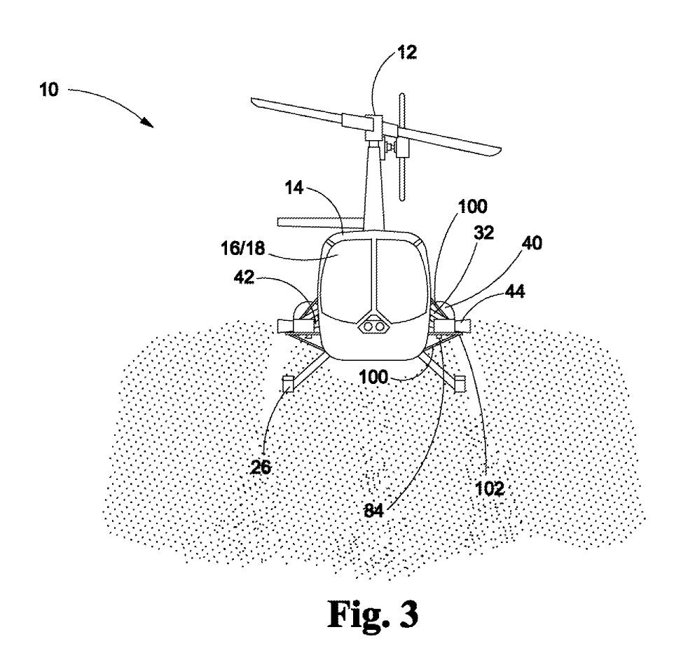

FIG. 4a is a perspective view of the helicopter of FIGS. 1-3, the view showing a side of the helicopter; the view showing a housing covering all but a portion of the feed tube and the outward end 74 of the venturi that protrudes outward from the outward side of the housing;

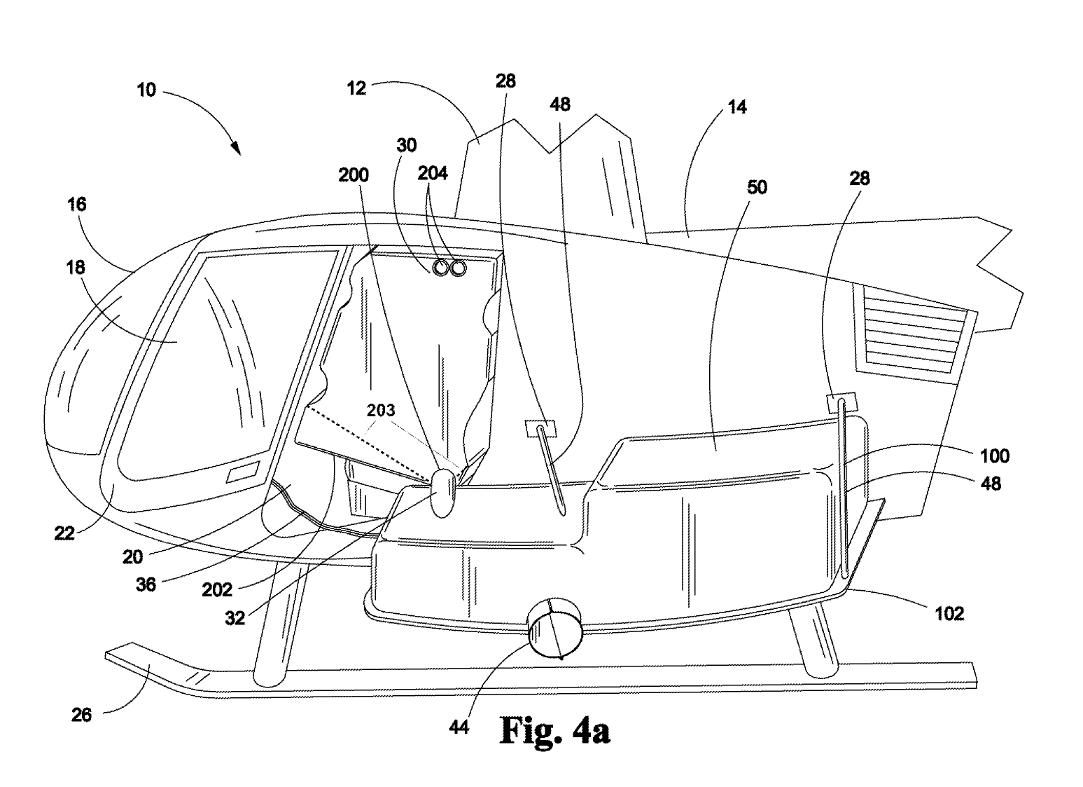

FIG. 4b is a perspective view of the helicopter of FIG. 4a, the view showing the housing removed;

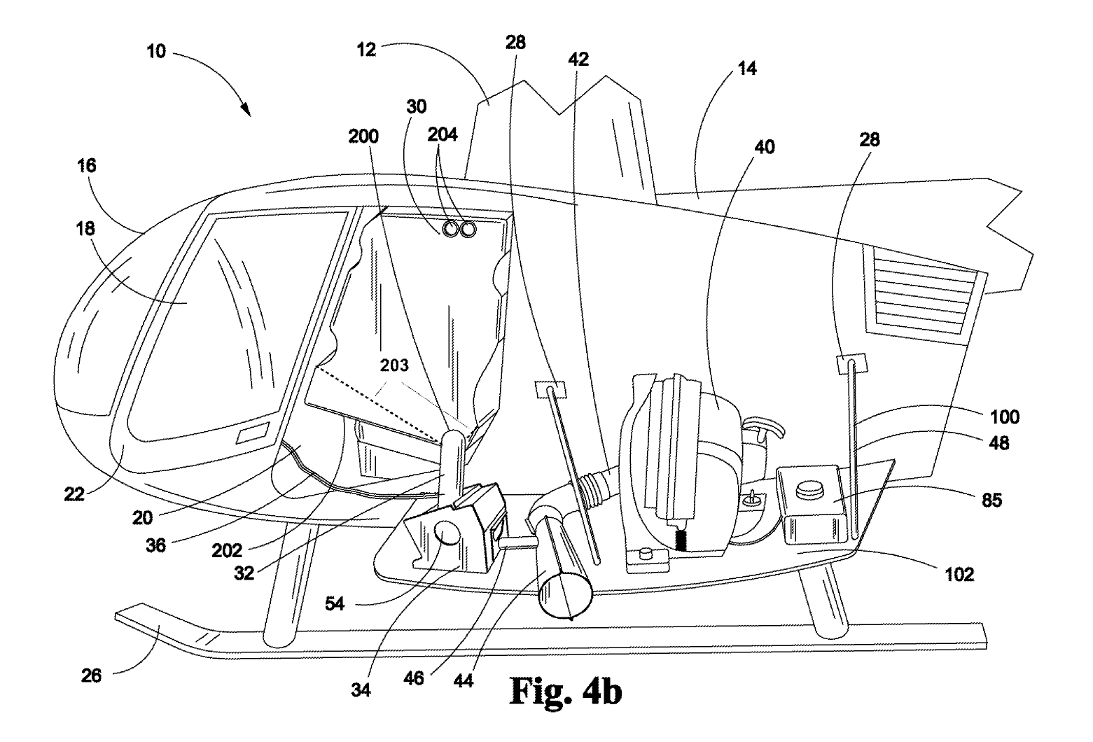

FIG. 5 is a perspective view of the seeding device, as is shown in FIGS. 1-4b, the view showing the helicopter removed;

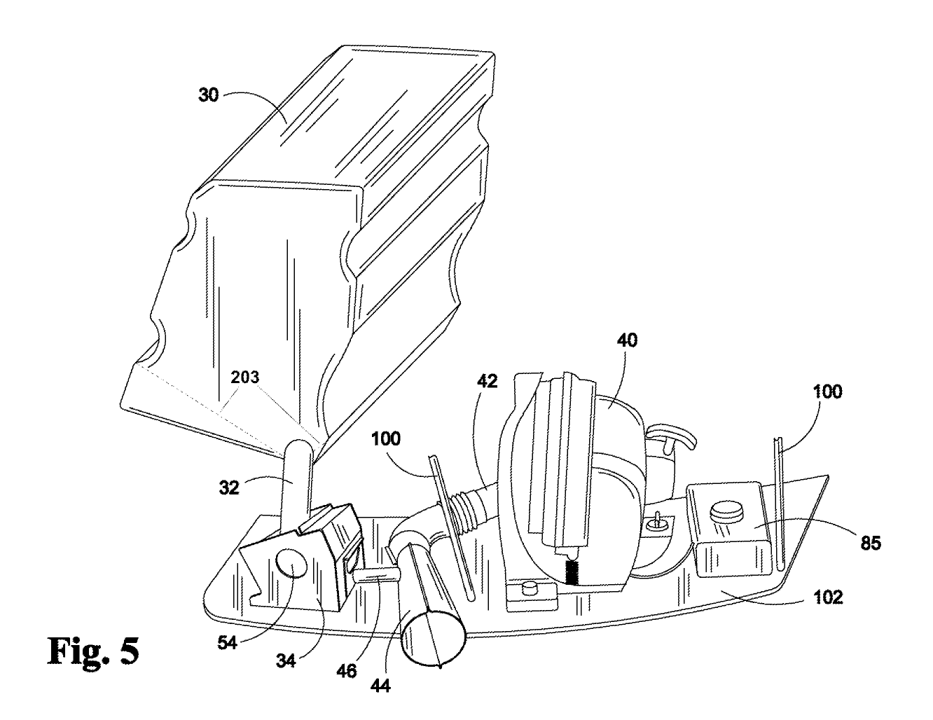

FIG. 6 is a close up perspective view of the seeding device, as is shown in FIG. 5, the view showing the helicopter removed; the view showing the seeding device having a bottom plate; the view showing a bin connected to a metering device that meters seed out of the bin, the bin and metering device connected by a feed tube that carries seed from the bin to the metering device; the view showing the metering device connected to a venturi by an inlet tube, the inlet tube configured to carry seed from the metering device to the venturi; the view showing the venturi connected to an air tube that is configured to carry pressurized air to the venturi; the view showing a cover member on the output side of the metering device, the view showing the cover having a vent covered by a screen to facilitate the introduction of air into the plenum to break the vacuum that could occur between the venturi and the metering device without the vent;

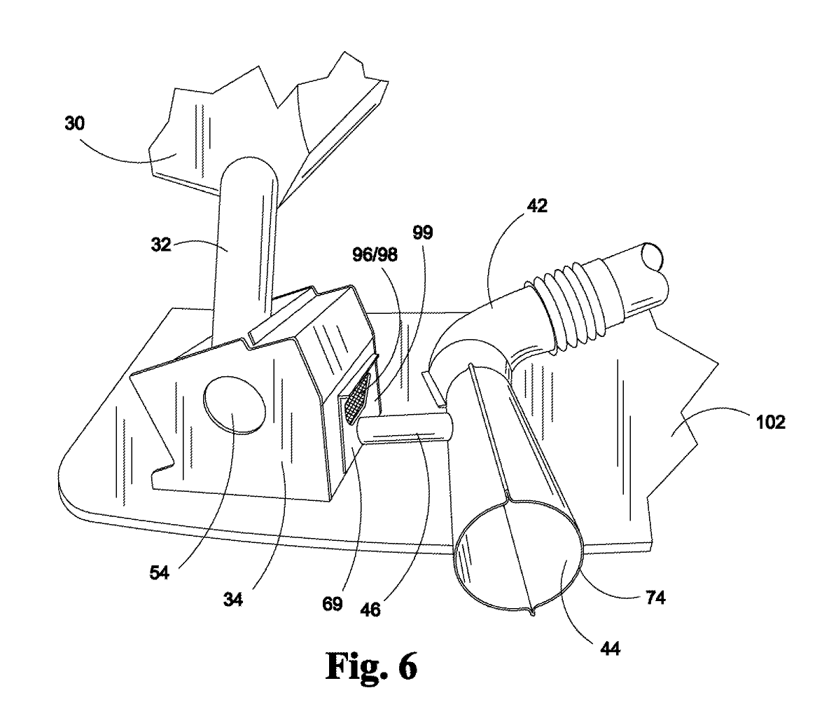

FIG. 7 is a close up elevation view of the top side of the seeding device, as is shown in FIG. 5, the view showing the helicopter removed; the view showing the seeding device having a bottom plate; the view showing the metering device connected to a venturi by an inlet tube, the inlet tube configured to carry seed from the metering device to the venturi; the view showing the venturi connected to an air tube that is configured to carry pressurized air to the venturi;

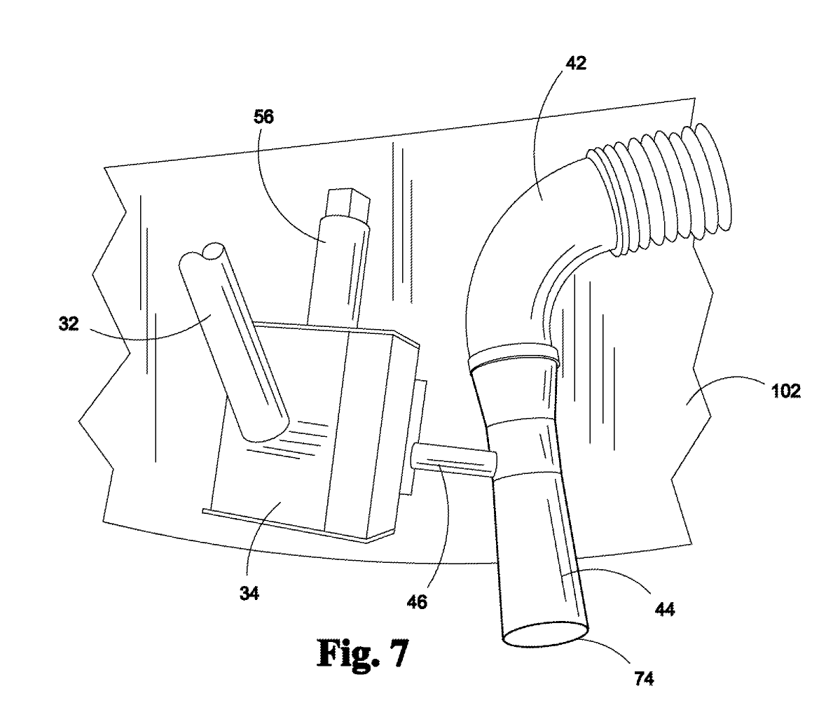

FIG. 8 is a close up side elevation view of the seeding device, as is shown in FIGS. 1-7, the view showing the helicopter removed; the view showing the seeding device having a bottom plate; the view showing a bin connected to a metering device that meters seed out of the bin, the bin and metering device connected by a feed tube that carries seed from the bin to the metering device; the view showing the metering device connected to a venturi by an inlet tube, the inlet tube configured to carry seed from the metering device to the venturi; the view showing the venturi connected to an air tube that is configured to carry pressurized air to the venturi; the view showing a cover member on the output side of the metering device, the view showing the cover having a vent covered by a screen to facilitate the introduction of air into the plenum to break the vacuum that could occur between the venturi and the metering device without the vent; the view showing the inlet tube extending a distance into the throat area of the venturi;

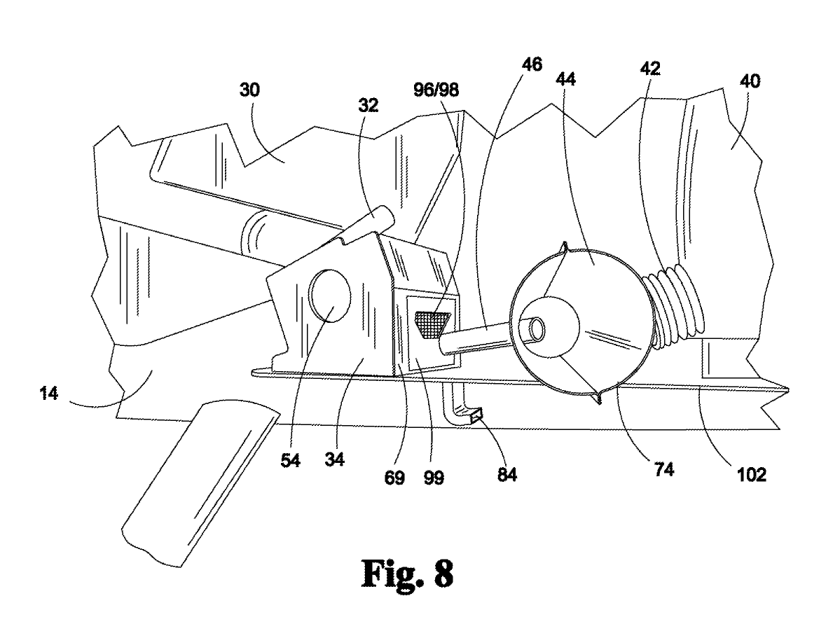

FIG. 9 is a close up perspective view of the metering device of the seeding device, as is shown in FIGS. 1-8; the view showing the metering device connected to a feed tube that is configured to deliver seed to an input side of the metering device; the view showing the metering device connected to a venturi by an inlet tube on an output side of the metering device, the inlet tube configured to carry seed from the metering device to the venturi; the view showing a motor connected to the metering device, the motor configured to operate a metering roll; the view showing a cover member on the output side of the metering device, the view showing the cover having a vent covered by a screen to facilitate the introduction of air into the plenum to break the vacuum that could occur between the venturi and the metering device without the vent; the view showing a motorized member connected to the metering device and configured to operate a secondary outlet for seed to be disbursed below the helicopter;

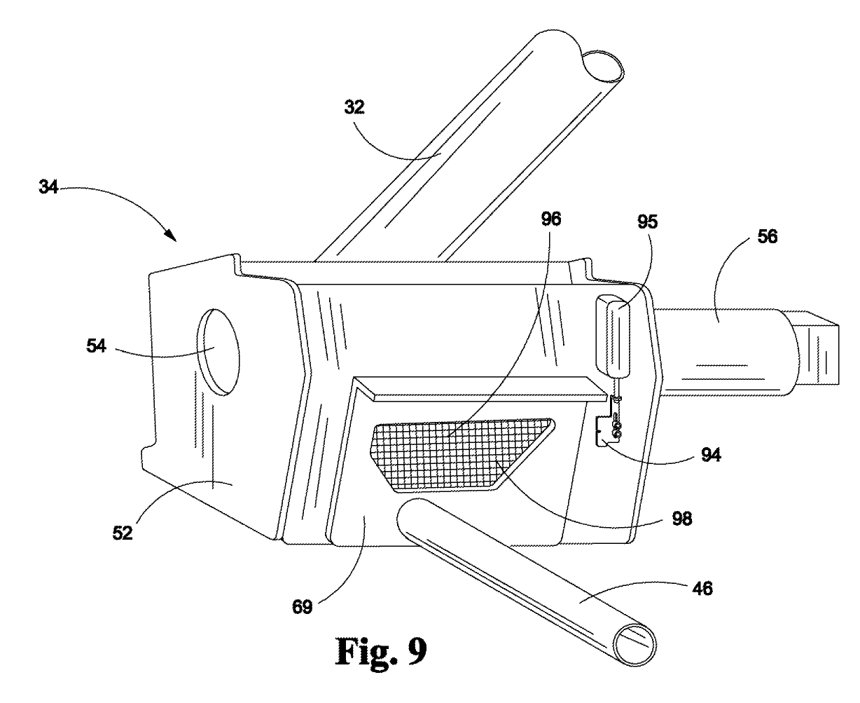

FIG. 10 is a close up side elevation cut-away view of the metering device of the seeding device, as is shown in FIG. 9; the view showing the metering device connected to a feed tube that is configured to deliver seed to an input side of the metering device; the view showing the metering device connected to a venturi by an inlet tube on an output side of the metering device, the inlet tube configured to carry seed from the metering device to the venturi; the view showing a metering roll positioned within the metering device and configured to move seed from an input side of the metering device to an output side of a metering device; the view showing a cover member on the output side of the metering device; the view showing trap door in the plenum for the dispersion of seed under the helicopter;

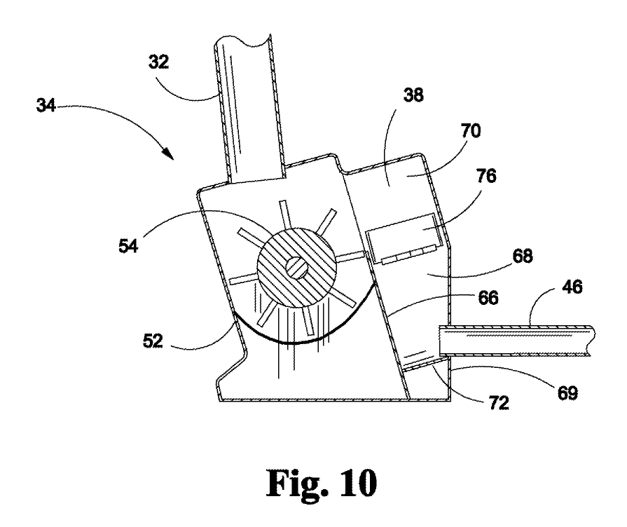

FIG. 11 is an exploded perspective view of the metering device as is shown in FIGS. 1-10; the view showing the metering device having an interior that is configured to receive a metering roll that is connected to a motor that operates the metering roll and configured to move seed from an input side of the metering device to an output side of a metering device; the view showing a plenum positioned on the output side of the metering device, the plenum having curved inner surface that gathers seed in a position where the seed can be sucked out of the plenum by an inlet tube; the view showing the metering device having a cover member having a vent that is covered by a screen that is held in place by a secondary cover; the view showing trap door in the plenum for the dispersion of seed under the helicopter; the view showing a motorized member 95 that is connected to the trap door and configured to control operation of the trap door;

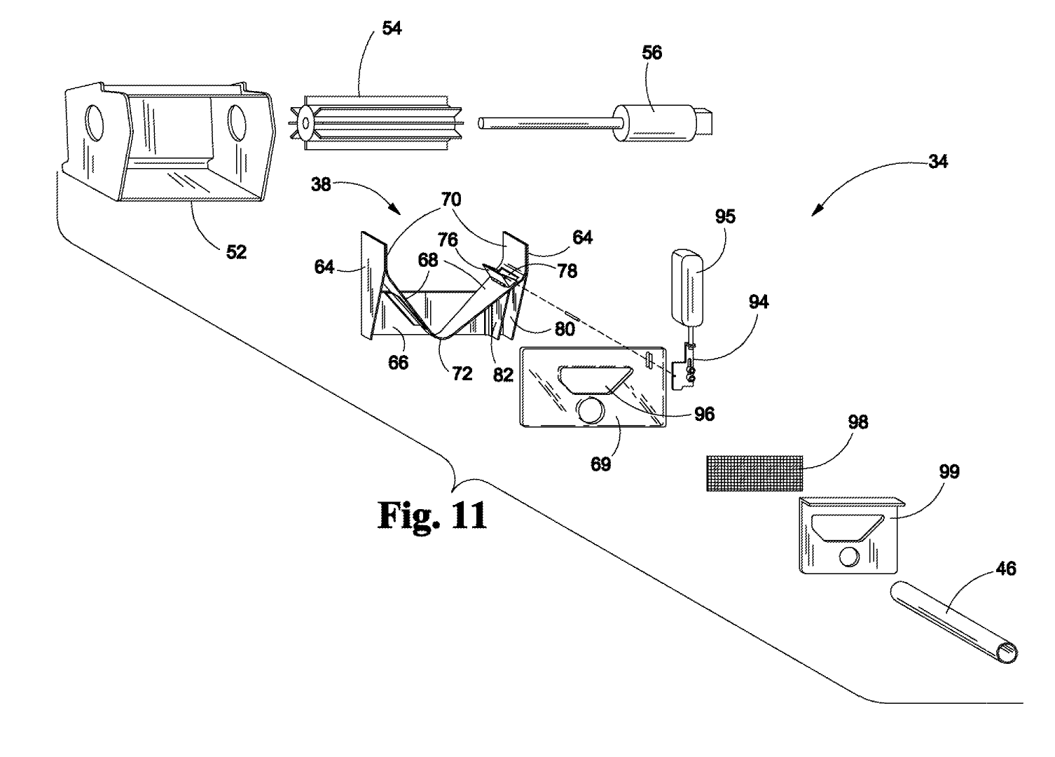

FIG. 12 is a close up exploded perspective view of the plenum shown in FIG. 11;

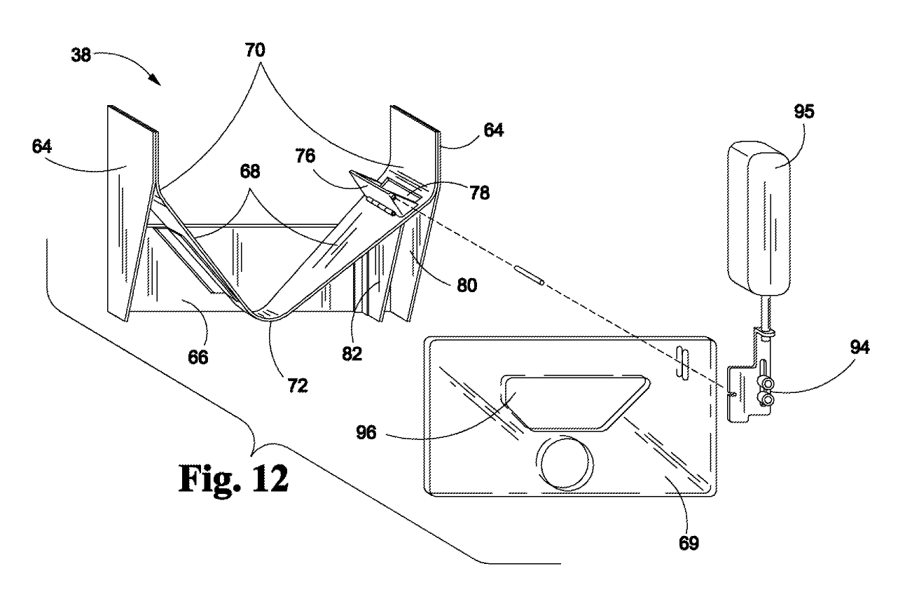

FIG. 13 is a close up cut-away elevation view of the venturi; the view showing the hollow interior of the venturi extending from the inward end to the outward end; the view showing the converging section adjacent the inward end; the view showing the diverging section adjacent the outward end; the view showing the throat section between the converging section and the diverging section; the view showing the inlet tube 46 entering a distance into the throat section of the venturi;

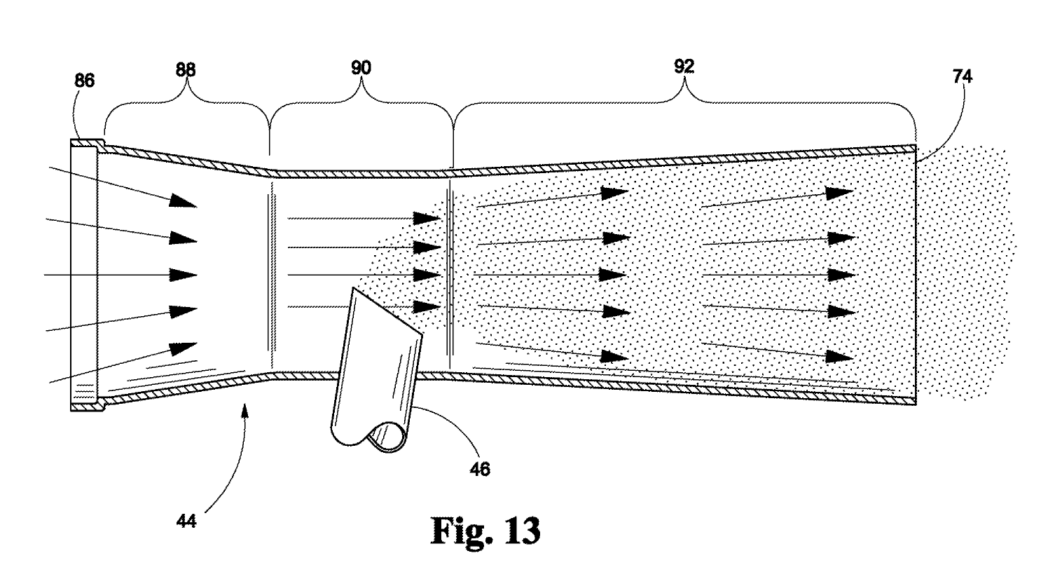

FIG. 14 is a demonstrative perspective view of the flow control system.

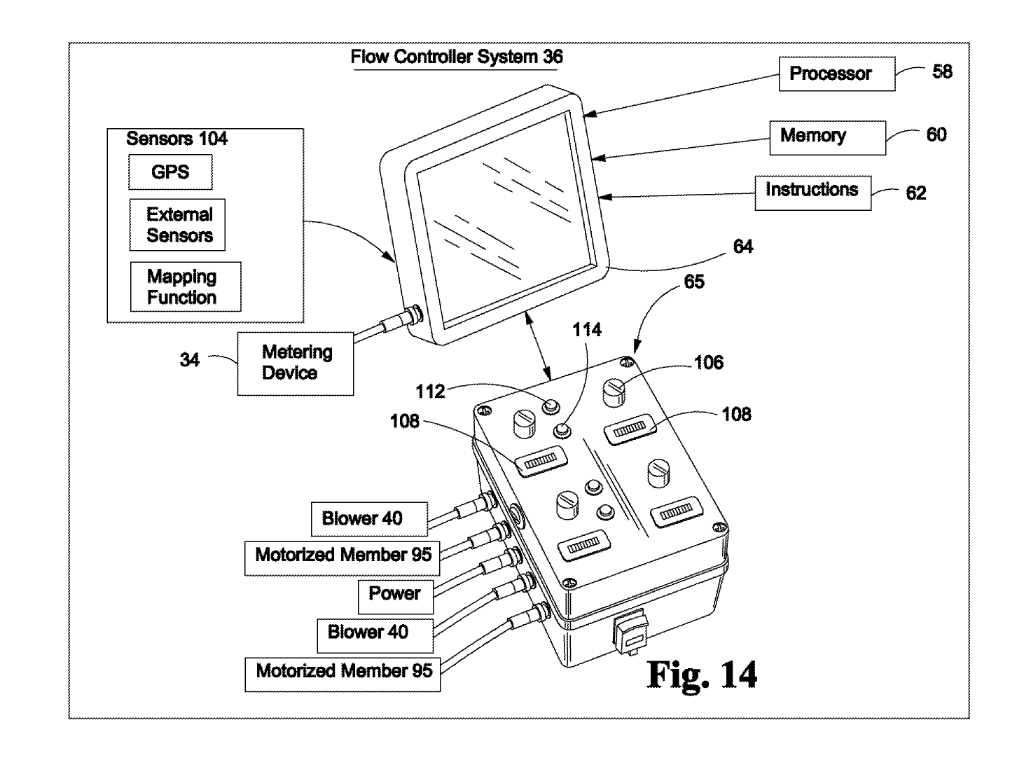

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention(s). The following detailed description is, therefore, not to be taken in a limiting sense, and the scope of the invention(s) is defined only by the appended claims, along with the full scope of equivalents to which such claims are entitled.

As used herein, the terminology such as vertical, horizontal, top, bottom, front, back, end, sides, left, right, and the like are referenced according to the views, pieces, parts, components and figures presented. It should be understood, however, that the terms are used only for purposes of description, and are not intended to be used as limitations. Accordingly, orientation of an object or a combination of objects may change without departing from the scope of the invention.

System:

With reference to the figures, a seeding device system 10 (system 10) is presented. The seeding device system 10, as is shown in the figures, is shown attached to a conventional helicopter 12. However use of the seeding device system 10 is not limited to use with a helicopter 12. Instead, the system can be used with any vehicle, such as combines, high-boy ground sprayers (such as those made by Hagie or John Deere), trucks, ATVs, utility vehicles (such as John Deere's Gator), fixed wing aircraft, drones, or any other vehicle. As such, reference to use of the system 10 in association with helicopter 12 is only for purposes of an example and no limitation should be imparted there to.

Similarly, while the system 10 is primarily described as being used for spreading cover crop seeds, this is meant only as one example and is not intended to be a limitation. In contrast, it is hereby contemplated that system 10 can be used for spreading any particulate matter, or flowable material including cover crop seeds, fertilizers, pesticides, herbicides, or any other particulate matter.

Also, the system 10 may be attached to only one side of the helicopter 12, or alternatively to both sides of the helicopter 12, as is shown. Alternatively, the system 10 may be attached to only one side of a vehicle, or alternatively to both sides of a vehicle.

Helicopter 12 can be any make, model, type, configuration or style of helicopter. As one example, a Robinson R44 Raven II helicopter is shown in the figures. Helicopter 12 includes the component parts of a fuselage 14 having a cockpit 16 with a front seat area 18 and a back seat or cargo area 20 which are accessible by front doors 22 and rear doors 24, respectively. Helicopter 12 is supported by skids 26 that connect to the lower side of fuselage 14 and includes hard points 28 that are used for mounting external components.

Seeding device system 10 includes the component pieces of a bin 30, a feed tube 32, a metering device 34, a flow controller system 36, a plenum 38, a blower 40, an air tube 42, a venturi 44, an inlet tube 46, a frame member 48 and a cover 50, among other components.

Bin:

Seeding device system 10 includes a bin 30. Bin 30 is formed of any suitable size, shape and design and is configured to hold bulk amounts of the material that is to be spread using the system, such as seed, fertilizer, pesticides, herbicides, chemicals, fire retardant, or any other particulate material, or any other material. In the arrangement shown, as one example, bin 30 is a rigid but somewhat flexible hollow container that fits with close and tight tolerances within the back seat or cargo area of the helicopter 12. Positioning bin 30 in this manner places the weight of the seed in approximately the same position where a back seat or cargo passenger would sit. Bin 30 is designed so that when filled with material to be disbursed, it weighs about as much as a large passenger (around 250 lbs.) using conventional seed. As such, positioning the bin 30 in this manner does not adversely affect the flying properties of the helicopter 30. Instead, with bin 30 positioned in the back seat or cargo area 20 of the helicopter 12, the helicopter 12 flies as if it has a back seat passenger, albeit a back seat passenger that gets lighter and lighter as the material is dispersed.

In one arrangement, in a single-sided system 10, bin 30 only fills one side of the back seat or cargo area 20 of the helicopter 12. In the event that a second system 10 is added to the opposite side of the helicopter 12, a second bin 30 is positioned on the other side of the back seat or cargo. This single bin 30 may be divided by a separator that extends across its approximate middle so as to divide the bin 30 into two separate but approximately equal compartments, one for the pilot/driver side and the other for the passenger side. In this way, even material consumption and dispersion is facilitated between systems on either side of helicopter 12. This also prevents massive shifts of weight from one side to the other during flying as the divider serves as a baffle preventing material movement. Alternatively, if only a single system 10 is used on one side of the helicopter 12, a single bin 30 may be used that fills both sides of the back seat or cargo.

In the arrangement shown, bin 30 includes the needed recesses and features to allow bin 30 to be easily inserted into and removed from the back seat or cargo area 20. In addition, bin 30 includes the needed recesses to provide clearance to allow the back seat or cargo door to be closed. As such, the addition of bin 30 does not affect the operation or emergency procedures of helicopter 12. In addition, the addition of bin 30 does not require substantive modification of the helicopter 12.

The lower end, and in one arrangement the outside lower rearward end, of bin 30 is connected to feed tube 32. To facilitate this connection, an opening 200 is placed at the lower outward end of bin 30. Opening 200 is formed of any suitable size, shape and design and facilitates connection of feed tube 32 thereto. In the arrangement shown, as one example, opening 200 has angled lower walls that facilitate the smooth transition of material out of bin 30.

As is also shown, as one example, bin 30 terminates at its lower end in a lower wall 202. A ramp 203 is positioned above lower wall 202 and angles slightly downward as it extends toward opening 200. The addition of ramp 203 above lower wall 202 helps to ensure that most if not all of the material in bin 30 flows out of bin 30 during operation. This arrangement makes opening 200 the lowest part, or near the lowest part, of the hollow interior of bin 30. The lower wall 202 of bin 30 angles downward as it extends rearward from its forward wall toward opening 200; the lower wall 202 of bin 30 angles downward as it extends forward from its rearward wall toward opening 200; the lower wall 202 of bin 30 angles downward as it extends outward from its center or divider wall toward opening 200. This arrangement makes opening 200 the lowest part, or approximately the lowest part of the hollow interior of bin 30. In one arrangement, as is shown, support material or filler material may be placed between lower wall 202 and the angled ram 203 to provide strength and support to bin 30 and to prevent ram 203 from collapsing under the weight of the seed within bin 30. In one arrangement, filler material between lower wall 202 and ram 203 is a foam material. In one arrangement, filler material between lower wall 202 and ramp 203 is a spray foam material that is sprayed into the space between lower wall 202 and ramp 203 that fills the space between lower wall 202 and ramp 203 and hardens into a rigid, but light, supporting material that prevents ramp 203 from collapsing under the weight of the material held within bin 30.

Bin 20 also includes one or more openings 204 positioned at its upper end. In one arrangement, opening 204 is formed of any suitable size, shape and design and is configured to facilitate the filling of material into bin 20 during use. In the arrangement shown, two openings 204 are shown for use, which speeds the filling process over only using a single opening 204. In the arrangement shown, as one example, these openings 204 are circular in shape and facilitate fast filling of material into bin 30 so that helicopter 12 does not need to be shut down during filling.

In arrangement, as is shown, two openings 204 are shown in use, one that serves as an inlet for the filling of seed or particulate matter and the other as an outlet for air to escape from the sealed container that is bin 30 during the filling process. In one arrangement, seed or particulate matter is filled by gravity into bin 30. In another arrangement, seed or particulate matter is filled by blowing. In either case a second opening 204 is useful in allowing air to escape from bin 30, otherwise bin 30 will become pressurized.

In one arrangement, wherein two openings 204 are used, one that is an inlet and one that is an outlet, a baffle member is placed over the opening 204 that serves as the outlet. This baffle member is formed of any suitable size, shape and design and serves to allow air to escape bin 30 while preventing seeds or particulate matter from escaping bin 30. In one arrangement, baffle member is simply a mesh or screen that covers the outlet opening 204 that lets air pass thereby but not seeds or particulate matter. In another arrangement, baffle member is a deflector or series of deflectors that lets air pass thereby but not seeds or particulate matter. These deflectors could be louvers, a series of angled walls or any other member that lets air pass thereby but not seeds or particulate matter. In another arrangement, baffle member is a snorkel member that extends inward from opening 204 into bin 30 a distance before extending upward. This snorkel member has an inlet end at or near the upper end of the bin 30. The use of snorkel member places the outlet at the highest possible water line. That is, having the opening or openings in snorkel member at or just below the inward surface of the top wall of bin 30 allows the bin 30 to be all but completely filled before seed or particulate matter will flow out of the opening 204 that serves as the outlet. Any other form of a baffle member is hereby contemplated for use to allow air to flow out of bin 30 but not seed or particulate matter.

In one arrangement, when two openings 204 are used, one as an inlet and one as an outlet, a tube of a filling device is connected to the opening 204 that serves as the inlet which allows seed or other particulate to flow into bin 30. As seed or particulate matter flows into bin 30 air flows out of the opening 204 that serves as the outlet. To prevent this air, and any dust, seeds, or other contaminants therein from blowing into the face of the person filling the bin 30, a deflector is connected to the opening 204 that serves as the outlet. This deflector is any device which deflects the air flowing out of the bin 30 away from the person filling the bin 30, away from the helicopter's rotor, or deflects that air flowing out of bin 30 in any other manner. In one arrangement, this deflector is a rigid or flexible tube or sock that connects to the opening 204 that serves as the outlet and extends downward a distance that terminates in an opening that points toward the ground, and away from the person filling the bin and away from the rotor, air intake, tail rotor or other sensitive parts of helicopter 12.

In one arrangement, while bin 30 is formed of a plastic, fiberglass or other composite material, the periphery of opening 200 and openings 204 are supported by a metallic member or other supporting material that strengthens the openings 200, 204 in bin 30 and also facilitates connection of components thereto, such as feed tube 32 to opening 200 and a filling tube to opening 204.

Feed Tube:

Seeding device system 10 includes a feed tube 32. Feed tube 32 is formed of any suitable size, shape and design and is configured to feed seed from bin 30 to the metering device 34. In the arrangement shown, as one example, feed tube 32 is a rigid or semi-flexible tube that extends out of the outside lower rearward end of bin 30 and connects to metering device 34. In one arrangement, as is shown, feed tube 32 is formed of a material that is rigid enough to withstand the demands of operation while also providing flexibility for ease of installation as well as allowing some relative motion between bin 30 and metering device 34 during use and flight.

While cover crop seed is generally very small and flows quite easily, in one arrangement, an agitator such as an impeller, auger or other movement device is positioned within bin 30 adjacent the inlet end of feed tube 32 or in feed tube 32 itself. The movement of agitator helps to prevent any sticky seed or blockage events and thereby helps to maintain constant flow of seed into and/or through the feed tube 32.

The steeper the angle of feed tube 32 the higher the likelihood that seed will efficiently flow through the feed tube 32. Angles of feed tube 32 of 27° or more have been tested with success, even under high-flow rate conditions.

Metering Device:

Seeding device system 10 includes a metering device 34. Metering device 34 is formed of any suitable size, shape and design and is configured to precisely meter out seed received from bin 30 and feed tube 32 so that the seed can be precisely dispersed according to a field prescription which may include seed density and location. In the arrangement shown, as one example, metering device 34 includes a housing 52 that includes one or more metering rolls 54 therein that is controlled by an electric motor 56 (which is controlled by flow control system 36). Seed is received within the housing 52 from feed tube 32 on one side of metering roll 54. In one arrangement, metering roll 54 is a generally cylindrical member that extends across the width of housing 52 and includes a plurality of grooves, recesses, fingers or features therein that receive seeds therein. As the metering roll 54 rotates, the grooves or fingers in the metering roll 54 carry seeds from one side of the housing 52 (the inlet side) to the other side of the housing 52 (the outlet side). When seeds are carried over the metering roll 54 they are dropped into the plenum 38, on the opposite side of back wall 66 where they are dispersed as is further described herein.

The amount of output of the metering device 34 is controlled by the flow controller system 36. That is, the flow controller system 36 controls the operation of and/or speed of metering roll 54.

Flow Control System:

Seeding device system 10 includes a flow control system 36. Flow control system 36 is formed of any suitable size, shape and design and is configured to track the speed, position and other operational characteristics of the helicopter 12 and with this information, control operation of the metering device 34 and other components of the system. In the arrangement shown, as one example, flow control system 36 includes a processor 58, memory 60, instructions 62 (such as software or source code) and one or more sensors 104, among other components. Processor 58 is any device that is capable of receiving information, interpreting the information according to instructions 62 stored in memory 60, and outputting instructions or commands. Memory 60 is any device that facilitates the storage and retrieval of information, such as instructions 62, as well as any other information. In one arrangement processor 58 and memory 60 are formed of separate components, in another arrangement processor 58 and memory 60 are formed of a combined unit or component, in yet another arrangement processor 58 and memory 60 are formed of a plurality of components. Sensors 104 are any device that senses the location or any other characteristic of operation of helicopter 12, or system 10, such as location through a GPS sensor or the like. Flow control system 36 includes any other sensors or inputs to facilitate operation of the system 10 including air speed indicators, altimeters, flow meters, scales, or the like.

Flow control system 36 also includes a mapping function. The mapping function allows a user to set up field prescriptions where the boundaries of a field are set up as well as the desired seed density, as well as any other salient feature important to aerial seeding. The flow control system 36 allows the user to set parameters such as how far the seed will be blown away from helicopter 12, and the like. The flow control system 36 also includes a display 63 that facilitates the display of information, such as the field boundaries, desired flight paths, and the like, and an input that facilitates the input and modification of that information, such as a keyboard, mouse, buttons, a touch screen or the like.

In the arrangement shown, as one example, the system 10/flow control system 36 includes an input 65 which in this example is a control box that includes a plurality of controls that are generally symmetric and are separated into left side control and right side control which allows for independent control of the left side and right side of the system 10. In the arrangement shown, this control box input 65 allows for pilot manual control of portions of the system 10 when manual control is desired.

In the arrangement shown, as one example, each side of control box input 65 includes trap door knob 106 that controls operation of trap door 76 and/or motorized member 95 and an associated indicator 108. Indicator 108 is any device that indicates the position of trap door knob 106 and/or trap door 76. In the arrangement shown, indicator 108 is an array of lights that indicate the position of trap door knob 106 and/or trap door 76.

In the arrangement shown, as one example, each side of control box input 65 also includes a blower knob 110 that controls operation of blower 40, such as a throttle, and an associated indicator 108. Indicator 108 is any device that indicates the speed of blower 40. In the arrangement shown, indicator 108 is an array of lights that indicate the position of trap door knob 106 and/or trap door 76. Also positioned adjacent the blower knob 110 and associated indicator 108 is an on button 112 and an off button 114 that turn the blower 40 on and off.

Flow control system 36 also allows for automated machine control of the blower 40, metering device 34, motorized member 95 and other components of the system 10, such as through the use of sensors 104, GPS and a mapping function such that when flying the system 10 controls itself and meters out the proper amount of seed at the proper time depending on the boundaries in the field in the mapping function.

In use, flow control system 36 senses or interprets the flight characteristics of the helicopter 12 and compares the position, altitude, speed, trajectory, user-set parameters and any other information to the field prescription and in response flow control system 36 controls the metering device 34 so as to disperse the optimum amount of seed at the optimum time.

Plenum:

Seeding device system 10 includes a plenum 38. Plenum 38 is formed of any suitable size, shape and design and is configured to catch the seed as it comes out of the output side of metering device 34 and holds the seed in position for the inlet tube 46 to suck the seed in into the venturi 44. The plenum 38 also serves the purpose of providing a vent between the venturi 44 and the metering device 34 so as to prevent the venturi 44 from sucking seed directly out of the metering device 34, and/or directly out of bin 30, which would influence or control the flow rate of the metering device 34.

In the arrangement shown, as one example, plenum 38 fits within the output side of housing 52 of metering device 34. In an alternative arrangement, plenum 38 is connected to the exterior of the output side of housing 52.

In the arrangement shown, plenum 38 includes a pair of generally planar sidewalls 64 that are positioned in approximate parallel spaced alignment to one another. A generally planar back wall 66 is connected to the rearward edge of sidewalls 64. Back wall 66 is positioned in approximate perpendicular alignment to sidewalls 64 and separates the input side of metering device 34 from the output side of metering device 34. Back wall 66 is generally flush with the bottom edge of sidewalls 64 but only extends up a portion of the height of sidewalls 64. In this way, the back wall 66 occupies the area below metering roll 54 of metering device 34. In this way, metering roll 54 serves to carry seed up and over the dam that is the back wall 66.

A guiding member 68 is positioned between sidewalls 64 and back wall 66. Guiding member 68 is formed of any suitable size, shape and design and is configured to gather the seed that falls out of the output side of metering roll 54 into a position where it can be efficiently sucked into the venturi 44. In the arrangement shown, guiding member 68 is a generally flat member that is approximately the same width as sidewalls 64. In this way, when a cover member 69 is placed over plenum 38 the interior surface of cover member 69 seals with the entire exterior edge of sidewalls 64 and guiding member 68. In the arrangement shown, guiding member 68 extends downward from the upper edge of sidewalls 64 in flat and flush engagement with sidewalls 64 for a distance. Guiding member 68 angles inward at first corner 70 at which point guiding member 68 continues to extend downward in a generally flat and planar member, albeit at an angle, until reaching an apex 72 at its lower end. Apex 72 is generally rounded having a bottom edge that is in approximate flat and flush alignment with the lower edge of sidewalls 64 and back wall 66. This shape helps to gather the seed falling out of metering device 34 and places it in a position where inlet tube 46 is able to easily suck the seed into venturi 44. In one arrangement, the diameter of curvature of apex 72 is approximately equal to the diameter of inlet tube 46.

Seeding device system 10 is configured to blow seed outward from the outward end 74 of venturi 44. Seeding device system 10 generally has a relatively even distribution of seed from the outward end 74 of venturi 44 to the termination point or farthest distance the seed is blown, which is generally 50 to 70 feet, or more specifically around 60 feet. Meaning that the seeds are quite evenly distributed from the outward end 74 of venturi 44 to the termination point. However, this means that when a seeding device system 10 is positioned on both sides of helicopter 12, there is an area of approximately the width of the helicopter 12 plus the widths of the ventures 44, or more specifically the distance from the outward end 74 of the passenger side venturi to the outward end 74 of the pilot/driver side venturi 44 that has not been adequately covered with seed. This distance can be anywhere from just a few feet to up to fifteen feet, depending on turbulent mixing characteristics resulting from unique airflow patterns generated by specific vehicles interacting with the outflow of the seed as it exits the venturi 44. Whereas, those airflow patterns may vary depending on the vehicles flight profile or speed over the ground.

To compensate for this characteristic, a trap door 76 is placed in the plenum 38, or more specifically in guiding member 68. Trapdoor 76 is connected at its lower edge to guiding member 68 by a hinge. In this way, trap door 76 can be positioned at any position from fully open to fully closed. Trap door 76 covers an opening 78 in guiding member 68 that allows a portion of the seed metered out of metering device 34 to bypass the venturi 44 and instead be directed to cover the area below helicopter 12 or other vehicle.

The seed that is captured by trap door 76 and passes through opening 78 passes through a channel 80 that is defined between a sidewall 64 and guiding wall 82. The seed that passes through trap door 76, opening 78 and channel 80 accounts for only a small portion of the overall amount of seed that is metered out of metering device 34. This seed is passed out the bottom of channel 80 and is directed through a secondary spreader 84 to cover the area below helicopter 12

Secondary spreader 84 is any device or configuration that spreads or guides seeds from trap door 76, opening 78 and channel 80 to the area under helicopter 12. In one arrangement, in its simplest form, secondary spreader 84 is simply one or a plurality of tubes that helps direct the falling seed below the helicopter 12. In another arrangement, secondary spreader 84 may be a second venturi system, like the venturi 44 described herein, albeit smaller and directed under the helicopter 12 instead of outward from the helicopter 12. In another arrangement, secondary spreader 84 may be an impeller spreading device. In another arrangement, secondary spreader 84 may blow seed under helicopter 12 with the diversion of a portion of the air flow generated by blower 40, or by air generated by a second blower 40. Any other manner, method or means of spreading seed beneath helicopter 12 is hereby contemplated for use as or in association with secondary spreader 84.

Trap door 76 may be fixed in place during a spreading operation, such as by setting a set screw or other locking device that holds trap door 76 in a rigid position. Alternatively, trap door 76 is movable during a spreading operation, such as by being controlled by a motorized member 95, such as a motor, solenoid or other electromechanical device. In this arrangement, flow controller system 36 or an independent controlling device, controls operation of trap door 76 in the same or a similar manner to the manner flow control system 36 controls metering roll 54. In the arrangement wherein secondary spreader 84 is a powered device, such as an impeller or the like, in one arrangement, flow control system 36 similarly controls operation of the secondary spreader 84 as well as the trap door 76.

Blower:

Seeding device system 10 includes a blower 40. Blower 40 is formed of any suitable size, shape and design and is configured to provide high velocity airflow to air tube 42 and venturi 44 so as to facilitate the spreading of seed. In the arrangement shown, as one example, blower 40 is a self-contained gasoline powered engine that is configured to power a fan and also includes an external fuel tank 85, however the use of a self-contained fuel tank is hereby contemplated for use. It is also contemplated that an electric-powered blower may be used which may be powered by electrical connection to the electrical system of the helicopter and/or by connection to dedicated batteries.

In the arrangement wherein blower 40 is a self-contained gasoline powered engine configured to power a fan, this provides the advantage of the blower 40 being independently powered and controlled from the helicopter 12. That is, when blower 40 is a self-contained gasoline powered engine, blower 40 does not draw power, or does not draw substantial power, from the electrical system of helicopter 12 which would be the case if blower 40 were an electrically powered blower motor electrically connected to the electrical system of helicopter 12. In this way, when blower 40 is a self-contained gasoline powered engine blower 40 can provide a suitable amount of power and airflow. In one arrangement, blower 40 provides a high quantity of air flow of up to approximately 210 mph, which allows air to be sucked into the venturi 44 through inlet tube 46 at approximately 140 mph and allows for seed to be drawn into venturi 44 at volumes exceeding 28 lbs. per minute, which is substantial. However, any other range of air speed is hereby contemplated for use. In one arrangement blower 40 is a conventional motor and fan arrangement used in back-pack-type leaf blowers and can either be a pull start or electric start and can either be a two stroke engine or a four stroke engine. In one arrangement, the throttle or speed of the blower 40, and therefore the speed or force at which the venturi 44 sucks in seed and blows out seed is controlled by the flow control system 36. That is, the flow control system 36 can turn on, turn off and adjust the speed or force of the blower 40 between a minimum speed (idling speed or off) and a maximum speed (full throttle).

The air flow output of blower 40 is fluidly connected to air tube 42 which fluidly connects to venturi 44.

In an alternative arrangement, blower 40 is an electric blower that either has its own power source or alternatively connects to the electrical system of helicopter 12. Any other form of a blower 40 is hereby contemplated for use.

Air Tube:

Seeding device system 10 includes an air tube 42. Air tube 42 is formed of any suitable size, shape and design and is configured to fluidly connect the air flow coming out of blower 40 to venturi 44. In the arrangement shown, as one example, air tube 42 is a hollow tube that may be rigid, flexible, semi-rigid or semi-flexible or a combination thereof Air tube 42 may be formed of a single piece or may be formed of a plurality of pieces that each may be rigid, flexible, semi-rigid or semi-flexible or a combination thereof.

In the arrangement shown, the airflow coming out of blower 40 is directed forward in relationship to helicopter 12 and air tube 42 redirects this air flow to connect to the inward end 86 of venturi 44 which directs the airflow outward from helicopter 12 through venturi 44.

Venturi:

Seeding device system 10 includes a venturi 44. Venturi 44 is formed of any suitable size, shape and design and is configured suck seed in and blow seed outward. In the arrangement shown, as one example, venturi 44 is generally cylindrical in shape and extends from an inward end 86, which connects to air tube 42 to an outward end 74 through which air and seed is blown out. Extending from inward end 86 to outward end 74, venturi 44 includes a converging section 88 that connects to throat 90 that connects to a diverging section 92.

Converging section 88 narrows the diameter of venturi 44 at an angle from the diameter of the inward end 86 to the diameter of the throat 90. Throat 90 is narrower in diameter than the inward end 86 of converging section 88 and outward end 74 of diverging section 92. Diverging section 92 expands the diameter of venturi 44 at an angle from the diameter of the throat 90 to the diameter of the outward end 74. Inlet tube 46 extends into venturi 44. In one arrangement, as is shown, inlet tube 46 extends into throat 90 of venturi 44 and feeds seeds into venturi 44 from plenum 38. In one arrangement, the converging section 88 angles inward at about 18° and the diverging section 92 angles outward at about 6°, however any other configuration of angles is hereby contemplated for use, including an inbound angle of anywhere from 10-30° or even more broadly from 5 to 45° including the ranges 17-19°, 16-20°, 15-21°, 14-22°, 13-23°, 12-24°, 11-25°, 10-26°; and an outbound angle of anywhere from 4-15° or even more broadly from 2-30° including the ranges 5-7°, 4-8°, 3-9°, 2-10°, 1-11°. The size, shape and design of venturi 44 harnesses the benefits of the Venturi Effect. The optimum size, shape, design, length, angles and other dimensions of venturi 44 are dependent on the operational characteristics of the use, such as air flow speed and quantity, the type of material being blown, the speed and direction of the helicopter 12, wind speed and direction, desired density of seeding, among countless other variables.

The Venturi Effect is the reduction in fluid pressure that results when a fluid flows through a constricted section (or choke or throat) of a pipe. In fluid dynamics, a fluid's velocity must increase as it passes through a constriction in accord with the principle of mass continuity, while its static pressure must decrease in accord with the principle of conservation of mechanical energy. Thus any gain in kinetic energy a fluid may accrue due to its increased velocity through a constriction is balanced by a drop in pressure. Due to the changes in pressure caused by the shape of the venturi 44 (the converging section 88, throat 90 and diverging section 92) air and therefore seed is sucked through inlet tube 46 and into venturi 44. This air and seed sucked into venturi 44 is then blown out the outward end of 74 of venturi 44.

As air pressure is used to suck seed into venturi 44 and air pressure and air flow is used to blow seed out of the outward end 74 of venturi 44 there is very little physical contact with the seed during this process. This gentle handling means that very few seeds are damaged during the process which increases the germination rate of the seed spread using this method. In one arrangement, it has been tested that less than 1% of the seeds suffer damage when being blown out of the system 10. In contrast, in impeller-type systems that utilize direct physical contact with the seed to sling the seed outward which causes up to 30% of the seeds to suffer damage.

In this arrangement, the seed travels by the weight of gravity through the bin 30, through the feed tube 32 and into the inlet side of metering device 34. The seed is then softly metered out by metering device 34 and falls by the weight of gravity into the plenum 38. As the seed falls into the plenum 38 the seed is gently guided by guiding member 68 until it is sucked into venturi 44 by inlet tube 46. By design, as the seed is sucked into venturi 44, while some of the seed hits the interior surface of the venturi 44 across from where the seed is introduced into the venturi 44, the contact is oblique and most of the seed is simply blown by the force of air out the outward end of venturi 44. As such, the process is quite fluid and does not damage the vast majority of seeds.

Inlet Tube:

Seeding device system 10 includes an inlet tube 46. Inlet tube 46 is formed of any suitable size, shape and design and is configured to provide a conduit for the seed to travel from the plenum 38 to the venturi 44. In the arrangement shown, as one example, inlet tube 46 is a cylindrical tube. The input end of inlet tube 46 is positioned at or near the apex 72 of plenum 38. The input end of inlet tube 46 is connected to either or both the plenum 38 or cover member 69 so as to hold it in optimum position to suck seeds into venturi 44.

The output end of inlet tube 46 connects to venturi 44. In one arrangement, the output end of inlet tube 46 extends into the throat 90 of venturi 44 a distance. In one arrangement, to help facilitate the flow of seed into venturi 44, inlet tube 46 does not enter venturi 44 in a perpendicular manner. Instead, inlet tube extends into venturi 44 at an angle. That is, the input end of inlet tube 46 is positioned nearer the inward end 86 of venturi 44 whereas the output end of inlet tube 46 is positioned nearer the outward end 74 of venturi 44. In one arrangement, as is shown, the portion of inlet tube 46 that extends into venturi 44 angles slightly from inward end 86 to outward end 74. As is also shown in this arrangement, as one example, the end of inlet tube 46 within venturi 44 terminates at an angle. That is, the end of inlet tube 46 within venturi 44 angles slightly, such that the upstream side of inlet tube 46 is slightly longer than the downstream side of inlet tube 46. The angle of inlet tube 46 and the angle of the end of inlet tube 46 help to facilitate seed being sucked through inlet tube 46, and help to prevent air from being blown into inlet tube 46 towards metering device 34.

Cover Member:

The input end of inlet tube 46 connects to or extends through cover member 69. Cover member 69 is formed of any suitable size, shape and design and is configured to cover the plenum 38. In the arrangement shown, cover member 69 is generally planar in shape and affixes to plenum 38 and or metering device 34 by any manner, method or means such as by screwing, bolting, locking, snap fitting, sliding and locking engagement, clamping or the like. In this arrangement, the interior surface of cover member 69 connects to or seals with the exterior surface of plenum 38 thereby keeping all the seed metered out of metering device 34 between the metering device 34 and the cover member 69. In the arrangement shown, cover member 69 includes an adjustment member 94, which may be controlled by a motorized member 95 such as a motor, solenoid or the like, that connects to trap door 76 and facilitates adjustment and setting of the position of trap door 76 to facilitate the flow of seed under helicopter 12. The input end of inlet tube 46 extends through the lower end of cover member 69 at or near the apex 72 of plenum 38. In this way, the inlet tube 46 is held in the optimum position to suck seed into venturi 44.

Cover member 69 includes a vent 96 therein that is covered by a screen 98. Vent 96 is formed of any suitable size, shape and design and is configured to provide air flow to plenum 38, or more specifically the area within the guiding member 68. In the arrangement shown, vent 96 is an opening in cover member 69. By providing free air flow to plenum 38, vent 96 prevents venturi 44, or inlet tube 46 from influencing the amount of seed being metered out of metering device 34. In contrast, if vent 96 were not between venturi 44 and plenum 38/metering device 34 the sucking force of venturi 44 would have a tendency to suck seed directly out of metering device 34, and the harder the venturi 44 sucked the more seed that would be pulled out of the metering device 34. In the arrangement utilizing vent 96, regardless of how hard the venturi 44 sucks, the metering device 34 operates independently and without influence from venturi 44. This independence facilitates higher levels of precision and accuracy of the metered seed. Additionally, by providing free air flow to plenum 38, vent 96 prevents venturi 44, or inlet tube 46 from negatively influencing the air flow and thereby the seed flow through the trap door outward from the plenum. In contrast, if vent 96 were not between venturi 44 and plenum 38/metering device 34 the sucking force of venturi 44 would have a tendency to prevent the free flow of seed through opening 78 allowing it to pass through channel 80 that is defined between sidewall 64 and guiding wall 82 of plenum 38.

Screen 98 facilitates air flow through vent 96 while keeping seed from falling out of plenum 38. Screen 98 also prevents material from being sucked into vent 96 and plenum 38, such as bugs, debris, and the like.

In one arrangement, a secondary cover 99 is positioned over screen 98 and vent 96 and is connected to cover member 69. By connecting secondary cover 99 over screen 98 and vent 96, screen 98 is held in place and supported around vent 96 by secondary cover 99. If and when screen 98 needs to be replaced, secondary cover 99 is removed, screen 98 is replaced and secondary cover 99 is reinstalled.

Frame Member:

Seeding device system 10 includes a frame member 48. Frame member 48 is formed of any suitable size, shape and design and is configured to connect the components of the system 10 to the helicopter 12. In the arrangement shown, as one example, frame member 48 is an Alaska Rack manufactured by Alaska Rack, LLC having an address of 3811 Laron Lane, Anchorage, Ak. 99504 and includes a plurality of braces 100 that connect to hard points 28 of the helicopter 12. In the arrangement shown, metering device 34, venturi 44, blower 40 and fuel tank 85 are directly connected to bottom plate 102 which is mounted to frame member 48. However any other arrangement is hereby contemplated for use for connecting system 10 to helicopter 12, or another vehicle. In the arrangement shown, cover 50 connects to and covers bottom plate 102 and/or a portion of bottom plate 102, and the components held therein.

Cover:

Seeding device system 10 includes a cover 50. Cover 50 is formed of any suitable size, shape and design and is configured to removably house and cover some or all of the components of system 10. In the arrangement shown, as one example, cover 50 is a generally hollow member that connects at its lower edge to bottom plate 102, or other components of helicopter 12, and is affixed thereto.

In the arrangement shown, metering device 34, plenum 38, cover member 69, inlet tube 46, venturi 44, air tube 42, blower 40 and fuel tank 85 are held within cover 50 with feed tube 32 extending into cover 50 and the outward end 74 of venturi 44 extending out of cover 50. Cover 50 shields these components from rain, airborne insects and debris, and the effects of the airflow caused by flying. In this way, cover 50 protects the components of system 10 and improves the repeatability of operation as cover 50 minimizes the effects of varying airflow on the system. Cover 50 also improves the aerodynamics of flying helicopter 12.

In one arrangement, as is shown, cover 50 is formed in a shape that does not prevent the opening or closing of the rear doors 24 or any other operation of the helicopter 12. As the shape of cover 50, and system 10 as a whole, does not affect the standard certificated operation of the helicopter 12, the system 10 does not change the established emergency procedures or require an additional certification for use.

In an alternative arrangement, the components of the system 10 are connected to or held within a Helipod Cargo Pod manufactured by Simplex Aerospace having an address of 13340 NE Whitaker Way, Portland, Oreg. 97230, or a similar device. Helipods are connected to the skid 26 of a helicopter 12, otherwise they function in a similar manner to the frame member 48 and cover 50 described herein.

The devices described herein do not limit any other configuration of attachment or cover of the system 10 which are hereby contemplated for use, including any other fabricated or manufactured device or method designed to carry, support, affix or cover the system 10 on an aircraft or other vehicle.

In Operation:

The system 10 is installed onto a helicopter 12 with the bin 30 positioned within the back seat area 20 of the helicopter 12 and frame member 48 is connected to hard points 28 with the cover 50 covering metering device 34, plenum 38, cover member 69, inlet tube 46, venturi 44, air tube 42, blower 40 and fuel tank 85. The bin 30 is filled with a desired seed or seed mixture while the helicopter 12 is on the ground. In the arrangement where blower 40 is a pull-start motor, the motor is started while the helicopter 12 is on the ground, otherwise the blower 40 motor can be started while in flight, which is especially easy to do when blower 40 is electric powered, or if blower 40 has an electric start to a gas powered engine.

Once started, the blower 40 blows air through air tube 42 and into venturi 44. As the air enters venturi 44 the air encounters the narrowing of converging section 88, then the air passes through the narrow throat 90 and out the diverging section 92 before passing the outward end 74 of venturi 44. The combined effect of the pressurized air passing through the venturi 44 causes air to be sucked through vent 96 in cover member 69 and through inlet tube 46 and into venturi 44. The air sucked through inlet tube 46 mixes with the air forced through venturi 44 from blower 40.

As the helicopter 12 travels, the flow controller system 36 tracks the position of the helicopter 12 and controls operation of the metering device 34. When flow controller system 36 senses that helicopter 12 is about to pass over a field boundary the flow controller system 36 activates metering roll 54 of metering device 34 and meters out a precise amount of seed according to the field prescription and the sensed variables and factors. Once metered out of the metering device 34 the seed falls by the weight of gravity into the plenum 38. As the seed falls into the plenum 38 the seed is guided by guiding member 68 until it is sucked into venturi 44 by inlet tube 46. As the seed is sucked into venturi 44, while some of the seed hits the interior surface of the venturi 44 across from where the seed is introduced into the venturi 44, most of the seed is simply blown by the force of air out the outward end of venturi 44. This process mixes that seed with the blown air making a relatively even dispersion of seed.

Once the seed is blown out the outward end 74 of venturi 44 the seed travels outward from the helicopter 12. The seed is further dispersed by the process of traveling to the ground. In addition, airflow from the blade of the helicopter 12 further disperses the seed. As such a relatively even distribution of seed is achieved.

In one arrangement, the trap door 76 is fixed in place by adjustment member 94. In an alternative arrangement, flow controller system 36 adjusts the position of the trap door 76 during flight using motorized member 95 thereby achieving the desired flow under helicopter 12 depending upon the height, speed, direction and other flight characteristics of the helicopter 12. As seed is metered out of metering device 34 a portion of the seed is diverged by trap door 76 to pass through channel 80 and through secondary spreader 84. This seed falls in the area beneath the helicopter 12 and helps to fill in the gaps between the area of dispersion of seeding device systems 10 positioned on opposing sides of the helicopter 12.

In one arrangement, as all components of the seeding device system 10 are rigidly affixed to the helicopter 12, the helicopter 12 is easily and predictably controlled. In addition, because of the small stature of the system 10 the aerodynamics of the helicopter 12 are not substantially changed. In addition, as most of the weight of the system 10 is carried in the position where the helicopter 12 is designed to carry similar weight (e.g. the back seat or cargo area 20) the helicopter 12 performs and handles much like when the helicopter 12 is carrying a pair of back seat or cargo passengers, albeit back seat or cargo passengers that get lighter as seed is dispensed. In addition, when a seeding device system 10 is attached to both sides of helicopter 12, the helicopter 12 is properly and evenly balanced.

Sensors:

In one arrangement, to provide a level of feed back to the pilot, one or more sensors 104 are attached to the system 10 to inform the pilot if the system 10 is performing appropriately. In one arrangement, one or more sensors 104 are positioned in the venturi 44 that detect whether appropriate air speed is being provided and whether seed is actually passing through the venturi 44. In another arrangement, one or more sensors 104 are positioned in the bin 30, feed tube 32 and/or the inlet side and/or outlet side of the metering device 34 to detect whether appropriate seed levels are being provided. Any other sensor or sensors are hereby contemplated for use to provide feedback to the pilot about the operation of the system 10 and to facilitate manual or automated control of the system 10.

Pilot Training & Cost Sharing:

It is well known that student pilots struggle to find the necessary hours flying aircraft due to the expense of operating aircraft. This is especially true for helicopters. One substantial benefit to the system 10 is that because it is rigidly attached to the helicopter 12 employing previously approved methods or devices for attachment, and does not affect emergency procedures, the system 10 can be operated with a Standard Airworthiness Certification under FAA Part 91 regulations. This allows the pilot to take a student pilot with them who can log flying hours toward certification or to provide time building opportunities to low-time pilots. Student pilots will gladly pay for this opportunity. This money can be used to subsidize or offset the operating costs of the helicopter and/or the seeding operation.

Adjustable Venturi:

In the arrangement shown, and described, venturi 44 is both fixed in size and shape and fixed in position relative to helicopter 12 and the other components of the system 10. When venturi 44 is fixed in size and shape and fixed in position there are limited variables that can be adjusted to effect the dispersion of seed over the field. To provide additional variables that can affect the dispersion of the seed over the field, venturi 44 is adjustable.

In one arrangement, the dimensions of venturi 44 are adjustable. That is, the length, diameter and/or shape of venturi 44 are adjustable in much the same way that the nozzle of a hose can be adjusted, or the nozzle at the end of a jet engine is adjustable. In one arrangement, the dimensions of the venturi 44 are adjustable in a manual manner, such that the user sets the dimensions of the venturi 44 and they remain static during operation. In another arrangement, the dimensions of the venturi 44 are adjustable in an automated or motorized manner, such that the flow control system 36 controls manipulation of the shape of the venturi 44 during use. Whether manual or automated, the shape of venturi 44 is adjusted to provide the best possible results and desired output depending on the unique variables at the time of use.

In another arrangement, the direction venturi 44 points is adjustable. This adjustability allows the venturi to be pointed in the optimal direction for the desired results. In one arrangement, the direction that venturi 44 points, is adjustable in a manual manner, such that the user sets the direction of venturi 44 which remains static during operation. In another arrangement, the direction that venturi 44 points, is adjustable in an automated or motorized manner, such that the flow control system 36 controls manipulation of the direction of the venturi 44 during use. Whether manual or automated, the direction of venturi 44 is adjusted to provide the best possible results and desired output depending on the unique variables at the time of use.

From the above discussion it will be appreciated that the seeding device system and related method of use, presented herein improves upon the state of the art.

Specifically, the seeding device system and method of use: improves upon the state of the art; is safe to use; is efficient to use; is simpler to use than prior art systems and methods; allows a training pilot to gain flying hours; does not require additional pilot certifications; does not affect the flight properties of the aircraft; is accurate; provides an even dispersion of seeds; does not hang down from the helicopter; does not damage seeds; is less expensive to use than prior art systems; is easier to use than prior art systems; is relatively inexpensive; provides helicopter owners another avenue of use and revenue; has an intuitive design; is rigidly affixed to the helicopter; is formed of a minimum number of parts; does not require substantial electrical draw from the helicopter; has a long useful life; is durable; does not require flying the helicopter in a special manner or with special precautions; does not affect emergency procedures; is easy to manufacture; has a robust design; is high quality; improves efficiencies; can be used with practically any helicopter as well as other aircraft; can be used with ground vehicles; can be used with a helicopter while meeting FAA Part 91 regulations (14 C.F.R. 91) General Operating and Flight Rules; and places the primary weight of the system in approximately the areas designed to hold the weight of passengers, among countless other advantages and improvements.

It will be appreciated by those skilled in the art that other various modifications could be made to the device without parting from the spirit and scope of this invention. All such modifications and changes fall within the scope of the claims and are intended to be covered thereby.

What is claimed:

1. A seeding device system connected to a vehicle, comprising:
a blower;
a venturi connected to the blower;
a metering device connected to a source of seed;
an inlet tube configured to feed seed into the venturi from the metering device;
wherein when the blower forces air through the venturi, seed metered out of the metering device is sucked into the venturi through the inlet tube and blown out the venturi.

2. The system of claim 1 wherein the vehicle is a helicopter.

3. The system of claim 1 further comprising a plenum positioned between the metering device and the inlet tube, wherein the plenum serves to break the vacuum between the venturi and the source of seed.

4. The system of claim 1 further comprising a plenum positioned between the metering device and the venturi, wherein the plenum serves to break the vacuum between the venturi and the source of seed.

5. The system of claim 1 further comprising a plenum positioned between the metering device and the venturi, wherein the plenum provides a source of air through a vent to break the vacuum between the venturi and the source of seed.

6. The system of claim 1 further comprising an opening between the metering device and the plenum that diverts a portion of the seed to cover the area under the vehicle.

7. The system of claim 1 further comprising a plenum positioned between the metering device and the inlet tube, the plenum having a vent that prevents the seed from being sucked out of the metering device by the venturi.

8. The system of claim 1 further comprising a flow control system connected to the metering device and configured to control operation of the metering device.

9. The system of claim 1 further comprising a flow control system connected to the metering device and configured to control operation of the metering device based on GPS positioning and a field prescription.

10. The system of claim 1 wherein the source of seed is a bin positioned in a back seat or cargo area of a helicopter.

11. A seeding device system connected to a helicopter comprising:
a blower;
a venturi connected to the blower;
a bin configured to house seed;
a metering device connected to the bin and configured to meter out seed;
an inlet tube connected to the venturi;
wherein when the blower forces air through the venturi, seed metered out of the metering device is sucked into the venturi and blown outward through the venturi and is dispersed.

12. The system of claim 11 wherein the bin is positioned in a back seat or cargo area of the helicopter.

13. The system of claim 11 further comprising a plenum positioned between the metering device and the inlet tube.

14. The system of claim 11 further comprising a plenum positioned between the metering device and the inlet tube, the plenum having an opening that diverts a portion of the seed to cover the area under the vehicle.

15. The system of claim 11 further comprising a plenum positioned between the metering device and the inlet tube, the plenum having a vent that prevents the seed from being sucked out of the metering device by the venturi.

16. The system of claim 11 further comprising a flow control system connected to the metering device and configured to control operation of the metering device.

17. The system of claim 11 further comprising a flow control system connected to the metering device and configured to control operation of the metering device based on GPS positioning and a field prescription.

18. A method of seeding, the steps comprising:
providing a first seeding device having a blower, a venturi, a bulk seed container, and a metering device;
connecting the first seeding device to a helicopter;
blowing air through the venturi using the blower;
metering seed out of the metering device;
sucking the metered seed into the venturi; and
blowing the seed out an end of the venturi thereby dispersing the seed.

19. The method of claim 18 wherein a vent is positioned between the venturi and the metering device.

20. The method of claim 18 further comprising the step of positioning a plenum between the metering device and the venturi.
